(19) United States
(12) Patent Application Publication
(10) Pub. No.: US 2009/0275257 A1
(43) Pub. Date: Nov. 5, 2009

(54) Process for Encapsulating LED Chip by Fluorescent Material

(76) Inventors: Ching-Cherng Sun, Jhongli City (TW); Tsung-Xian Lee, Jhongli City (TW); Chun-te Wu, Jhongli City (TW)

Correspondence Address: HDLS Patent & Trademark Services, P.O. BOX 220746, CHANTILLY, VA, 20153-0746, US

(21) Appl. No.: 12/189,138

(22) Filed: Aug. 9, 2008

(30) Foreign Application Priority Data
May 5, 2008 (TW) 097116534

(51) Int. Cl. H01J 9/02; H05B 7/00

(52) U.S. Cl. 445/50; 264/453

(57) ABSTRACT

An LED chip encapsulation process includes the steps of (a) forming a fluorescent member by injection molding to encapsulate an LED chip; (b) hardening the fluorescent member; (c) forming a transparent dome to embed and encapsulate the LED chip and the fluorescent member; and (d) securing the dome and the substrate together to finish a packaging of the LED chip. Shape of the fluorescent member disposed on the LED chip can be controlled precisely, thereby increasing quality and color uniformity of the produced LED chip. Alternatively, the LED chip is a remote LED chip and step (a) is replaced by forming a plastic member to encapsulate the LED chip and forming a fluorescent member on the top of the plastic member by injection molding.

### BACKGROUND OF THE INVENTION

1. Field of Invention

The invention relates to LED chip manufacturing and more particularly to a process for encapsulating an LED chip on an insulating substrate by injection molding a fluorescent member into which a fluorescent material for wavelength conversion is added so that the shape of the fluorescent member disposed on the LED chip can be controlled precisely, thereby increasing quality and color uniformity of the produced LED chip.

2. Description of Related Art

A conventional process for manufacturing an LED (light-emitting diode) chip capable of emitting white light involves a wavelength conversion material (e.g., fluorescent material) that is excited by light emitted from the LED chip. In detail, the process comprises causing an LED chip capable of emitting blue light to emit blue light for exciting a fluorescent material disposed thereabove; and converting a portion of blue light into yellow light which is in turn mixed with blue light emitted by the LED chip capable of emitting blue light to obtain white light.

A process for encapsulating a remote LED chip by a fluorescent material comprises causing an LED chip capable of emitting blue light to emit blue light for exciting a fluorescent material added in a resin (e.g., epoxy resin or silicon rubber) disposed thereabove; and converting a portion of blue light into yellow light which is in turn mixed with blue light emitted by the LED chip capable of emitting blue light to obtain white light. The process can produce LED chips capable of emitting white light with an increased brightness.

Quality and color uniformity of the LED chips capable of emitting white light are closely associated with density, size, and location of the fluorescent material disposed on the LED chip. Further, the most important factor is the shape of the fluorescent material disposed on the LED chip.

The process for encapsulating LED chip capable of emitting white light by a fluorescent material is the most important process in LED chip manufacture. Generally speaking, almost all semiconductor manufacturing companies can produce LED chips capable of emitting white light with sufficient brightness. However, the well known process for encapsulating LED chip by a fluorescent material suffers from a number of disadvantages as detailed below.

The fluorescent material is disposed on the LED chip by dropping which unfortunately may distribute the fluorescent material on the LED chip in a non-uniform fashion. Hence, shape of the resin with fluorescent material added therein cannot be controlled precisely. And in turn, optical properties of the LED chips capable of emitting white light are adversely affected. For example, many commercially available LED lamps having such LED chips capable of emitting white light as a light source experience the problem of non-uniform color temperature (CT) distribution (i.e., so-called halo phenomenon). Moreover, CT of the LED chip is distributed abnormally due to settling down of the fluorescent material. As a result, lighting applications of such LED chips are limited. Moreover, there are no inventions disclosed an improved process for encapsulating LED chip by a fluorescent material of which the inventor is aware. Thus, a need for improvement exists.

### SUMMARY OF THE INVENTION

It is therefore one object of the invention to provide a process for encapsulating LED chip by a fluorescent material comprising forming a fluorescent member by injection molding to encapsulate the LED chip and forming a transparent dome to embed and encapsulate the fluorescent member so that LED chip packaging can be effected.

It is another object of the invention to provide a process for encapsulating a remote LED chip by a fluorescent material comprising after forming a plastic member to encapsulate the LED chip forming a fluorescent member on the top of the plastic member by injection molding, and forming a transparent dome to embed and encapsulate the LED chip, the fluorescent member, and the plastic member. Size and shape of the plastic member are determined by the distance between the LED chip and the fluorescent member.

The invention has the following advantages.

The shape of the fluorescent member can be controlled precisely by injection molding, thereby increasing quality and color uniformity of the produced LED chip.

Uniformity of the fluorescent member can be increased. The problem of non-uniform CT distribution of LED chips capable of emitting white light due to settling down of the fluorescent material can be solved

The shape of the fluorescent member can be controlled depending on applications and the shape of the fluorescent member can be selected from a number of different shapes.

The fluorescent member and the transparent dome are integrally so that the manufacturing process can be simplified.

The process for encapsulating an LED chip by a fluorescent member is advantageous over the well known dropping technique. Moreover, a process for encapsulating a remote LED chip by a fluorescent material is made possible.

The packaging of LED chip can be implemented by the process for encapsulating LED chip by a fluorescent material of the invention. Further, the LED chips can be advantageously employed as light source of lighting devices.

The above and other objects, features and advantages of the invention will become apparent from the following detailed description taken with the accompanying drawings.

### BRIEF DESCRIPTION OF THE DRAWINGS

FIG. 1 schematically depicts a process for encapsulating an LED chip on a substrate by a fluorescent material according to the invention;

FIG. 2 schematically depicts a process for encapsulating a remote LED chip on a substrate by a fluorescent material according to the invention; and

FIG. 3 is a flowchart depicting a process for encapsulating an LED chip on a substrate by a fluorescent material according to the invention.

### DETAILED DESCRIPTION OF THE INVENTION

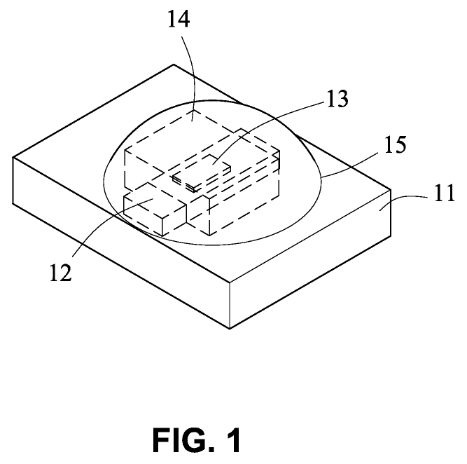

Referring to FIG. 1, a process for encapsulating LED chip on a substrate by a fluorescent material in accordance with the invention is schematically illustrated. First, an insulating substrate 11 is provided. Next, a raised platform 12 is provided on the substrate 11. Next, an LED chip 13 is provided on the platform 12. Next, a member with a fluorescent material for wavelength conversion added therein (i.e., fluorescent member) 14 is provided by injection molding to encapsulate the LED chip 13 and a portion of the platform 12. Thereafter, the fluorescent member 14 is hardened by cooling or heating. Next, a transparent material (e.g., glass, silicon rubber, or resin) is selected to form a transparent dome 15 with the platform 12, the LED chip 13, and the fluorescent member 14 is embedded and encapsulated therein. Finally, securing the dome 15 and the substrate 11 together to finish the process for encapsulating LED chip on a substrate by a fluorescent material.

The transparent dome 15 can also be formed by, for example, injection molding in this embodiment prior to encapsulating the fluorescent member 14. Mold for forming the fluorescent member 14 by injection molding can have a shape with a flat surface, wavy surface, arcuate surface, or irregular surface depending upon applications. Hence, shape of the fluorescent member 14 encapsulating the LED chip 13 can be precisely controlled by injection molding.

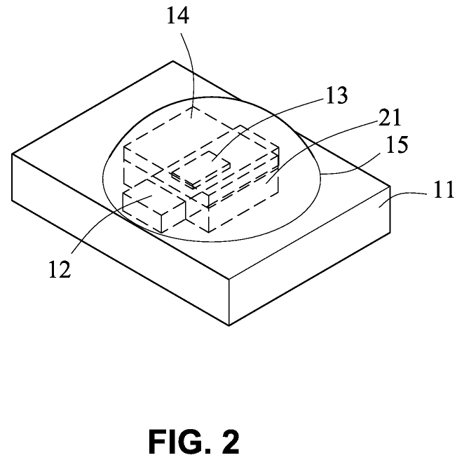

Referring to FIG. 2, a process for encapsulating a remote LED chip on a substrate by a fluorescent material in accordance with the invention is schematically illustrated. First, a plastic material (e.g., epoxy resin or silicon rubber) is employed to form a plastic member 21 to encapsulate the LED chip 13 and a portion of the platform 12. Thereafter, a member with a fluorescent material for wavelength conversion added therein (i.e., fluorescent member) 14 is provided on the top of the plastic member 21. Next, the fluorescent member 14 is hardened by cooling or heating. Next, a transparent material (e.g., glass, silicon rubber, or resin) is selected to form a transparent dome 15 with the platform 12, the LED chip 13, the plastic member 21, and the fluorescent member 14 embedded and encapsulated therein, finally, securing the dome 15 and the substrate 11 together.

Note that size and shape of the plastic member 21 are determined by the distance between the LED chip 13 and the fluorescent member 14. Moreover, the plastic member 21 can be formed either by injection molding in this embodiment or by any of other techniques known in the art.

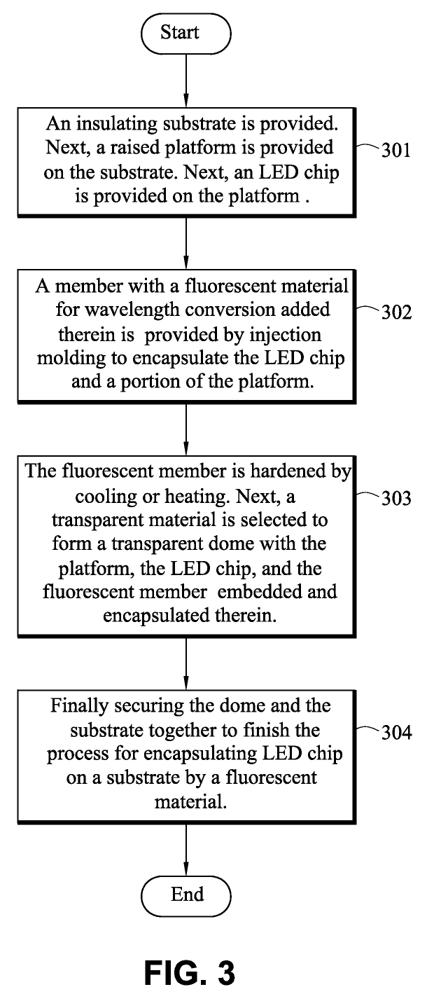

Referring to FIG. 3, a flowchart depicting a process for encapsulating an LED chip on a substrate by a fluorescent material according to the invention is illustrated.

In step 301, first an insulating substrate 11 is provided. Next, a raised platform 12 is provided on the substrate 11. Next, an LED chip 13 is provided on the platform 12.

In step 302, a member with a fluorescent material for wavelength conversion added therein (i.e., fluorescent member) 14 is provided by injection molding to encapsulate the LED chip 13 and a portion of the platform 12.

In step 303, the fluorescent member 14 is hardened by cooling or heating. Next, a transparent material (e.g., glass, silicon rubber, or resin) is selected to form a transparent dome 15 with the platform 12, the LED chip 13, and the fluorescent member 14 embedded and encapsulated therein.

In step 304, finally securing the dome 15 and the substrate 11 together to finish the process for encapsulating LED chip on a substrate by a fluorescent material.

Note that in a process for encapsulating a remote LED chip on a substrate by a fluorescent material in accordance with the invention a plastic material (e.g., epoxy resin or silicon rubber) is employed to form a plastic member 21 to encapsulate the LED chip 13 and a portion of the platform 12 prior to step 302. Thereafter, a member with a fluorescent material for wavelength conversion added therein (i.e., fluorescent member) 14 is provided on the top of the plastic member 21. Next, the fluorescent member 14 is hardened by cooling or heating in step 303. It is further noted that size and shape of the plastic member 21 are determined by the distance between the LED chip 13 and the fluorescent member 14.

The invention has the following advantages.

The shape of the fluorescent member 14 can be controlled precisely by injection molding, thereby increasing quality and color uniformity of the produced LED chip 13.

Uniformity of the fluorescent member 14 can be increased. The problem of non-uniform CT distribution of LED chips capable of emitting white light due to settling down of the fluorescent material can be solved. Therefore, an LED chip 13 with high brightness and uniform CT distribution can be produced in a reliable manufacturing process.

The shape of the fluorescent member 14 can be controlled depending on applications and the shape of the fluorescent member 14 can be selected from a number of different shapes.

The fluorescent member 14 and the transparent dome 15 are integrally so that the manufacturing process can be simplified.

The process for encapsulating an LED chip by a fluorescent member is advantageous over the well known dropping technique. Moreover, a process for encapsulating a remote LED chip by a fluorescent material is made possible.

The packaging of LED chip 13 can be implemented by the process for encapsulating LED chip by a fluorescent material of the invention. Further, the LED chips 13 can be advantageously employed as light source of lighting devices.

While the invention herein disclosed has been described by means of specific embodiments, numerous modifications and variations could be made thereto by those skilled in the art without departing from the scope and spirit of the invention set forth in the claims.

What is claimed is:

1. A process for encapsulating an LED chip comprising the steps of:
(a) providing an insulating substrate;
(b) providing a platform on the substrate;
(c) providing an LED chip on the platform;
(d) forming a fluorescent member by injection molding to encapsulate the LED chip;
(e) hardening the fluorescent member;
(f) forming a transparent dome by a transparent material to embed and encapsulate the LED chip and the fluorescent member; and
(g) securing the transparent dome and the substrate together to finish a packaging of the LED chip.

2. The process of claim 1, wherein the LED chip is a remote LED chip and wherein step (d) is replaced by the steps of forming a plastic member to encapsulate the LED chip and forming a fluorescent member on the top of the plastic member by injection molding.

3. The process of claim 2, wherein a mold for forming the fluorescent member by injection molding is adapted to have a shape with a flat surface, wavy surface, arcuate surface, or irregular surface.

4. The process of claim 2, wherein the fluorescent member is hardened by cooling or heating.

5. The process of claim 1, wherein the transparent material is glass, silicon rubber, or resin.

6. The process of claim 1, wherein the transparent dome is formed by injection molding.

7. The process of claim 2, wherein the size and the shape of the plastic member are determined by the distance between the LED chip and the fluorescent member.

8. The process of claim 2, wherein the plastic material is either epoxy resin or silicon rubber.

9. The process of claim 2, wherein the plastic member is formed by injection molding.
